(19) United States
(12) Patent Application Publication
(10) Pub. No.: US 2026/0038482 A1
(43) Pub. Date: Feb. 5, 2026

(54) SPEECH PROCESSING METHOD AND APPARATUS, DEVICE, AND STORAGE MEDIUM

(71) Applicant: Tencent Technology (Shenzhen) company Limited, Shenzhen (CN)

(72) Inventors: Zhiyuan TANG, Shenzhen (CN); Shen HUANG, Shenzhen (CN); Shidong SHANG, Shenzhen (CN)

(21) Appl. No.: 19/353,437

(22) Filed: Oct. 8, 2025

Related U.S. Application Data
(63) Continuation of application No. PCT/CN2024/104969, filed on Jul. 11, 2024.

(30) Foreign Application Priority Data
Sep. 12, 2023 (CN) 202311171159.5

(51) Int. Cl. G10L 15/06; G10L 15/02; G10L 15/18

(52) U.S. Cl. CPC G10L 15/063; G10L 15/02; G10L 15/1822; G10L 2015/0631

(57) ABSTRACT

A speech-to-text conversion method is performed by a computer device. The method includes: extracting target speech representation information from to-be-processed speech data, the target speech representation information comprising a speech content vector and a paralinguistic vector that correspond to the to-be-processed speech data; obtaining a prompt word about the to-be-processed speech data separately; performing fusion processing on the speech content vector, the paralinguistic vector, and the prompt word, to obtain a speech fusion feature; and performing speech conversion processing on the to-be-processed speech data according to the speech fusion feature, to obtain the text information corresponding to the to-be-processed speech data. The speech-to-text method can improve accuracy of speech recognition. Embodiments of this application are used, so that the accuracy of the speech recognition can be improved.

### CROSS-REFERENCE TO RELATED APPLICATIONS

This application is a continuation application of PCT Patent Application No. PCT/CN2024/104969, entitled “SPEECH PROCESSING METHOD AND APPARATUS, DEVICE, AND STORAGE MEDIUM” filed on Jul. 11, 2024, which claims priority to Chinese Patent Application No. 2023111711595, entitled “SPEECH PROCESSING METHOD AND APPARATUS, DEVICE, AND STORAGE MEDIUM” filed with the China National Intellectual Property Administration on Sep. 12, 2023, all of which are incorporated by reference in its entirety.

### FIELD OF THE TECHNOLOGY

This application relates to the field of artificial intelligence technologies, and in particular, to a speech processing method and apparatus, a device, and a storage medium.

### BACKGROUND OF THE DISCLOSURE

A speech recognition technology is applied to a plurality of scenarios. For example, in an intelligent conversation scenario, speech recognition and understanding are performed on speech data of a dialogist, so that a meaning that the dialogist intends to express can be learned, so as to select corresponding reply data for an accurate reply. However, in addition to text content, the speech data of the dialogist usually further includes auxiliary information configured for assisting in recognizing the speech data of the dialogist. However, the current speech recognition and understanding technology only converts the speech data of the dialogist into text information, and the auxiliary information in the speech data cannot be reflected in the text information, resulting in low accuracy of speech recognition.

### SUMMARY

Embodiments of this application provide a speech processing method and apparatus, a device, and a storage medium, to improve accuracy of speech recognition.

According to a first aspect, this application provides a speech-to-text conversion method, including:
extracting target speech representation information from to-be-processed speech data, the target speech representation information comprising a speech content vector and a paralinguistic vector that correspond to the to-be-processed speech data;
obtaining a prompt word about the to-be-processed speech data;
performing fusion processing on the speech content vector, the paralinguistic vector, and the prompt word, to obtain a speech fusion feature; and
performing speech conversion processing on the to-be-processed speech data according to the speech fusion feature, to obtain the text information corresponding to the to-be-processed speech data.

According to a third aspect, this application provides a computer device, including a processor, a memory, and a network interface. The processor is connected to the memory and the network interface, the network interface is configured to provide a data communication function, the memory is configured to store a computer program, and the processor is configured to invoke the computer program, to cause the computer device to perform the foregoing speech-to-text conversion method.

According to a fourth aspect, this application provides a non-transitory computer-readable storage medium. The computer-readable storage medium stores a computer program, and the computer program is suitable for being loaded and executed by a processor, to cause a computer device having the processor to perform the foregoing speech-to-text conversion method.

In embodiments of this application, feature extraction is performed on to-be-processed speech data to obtain target speech representation information of the to-be-processed speech data. A prompt word about the to-be-processed speech data is obtained, and fusion processing is performed on the target speech representation information and the prompt word, to obtain a speech fusion feature. Speech conversion processing is performed on the speech fusion feature, to obtain text information corresponding to the to-be-processed speech data. The target speech representation information includes a speech content vector and a paralinguistic vector that correspond to the to-be-processed speech data, and the paralinguistic vector is configured for assisting in recognizing the text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word. Because more comprehensive and abundant speech representation information is used for speech recognition processing, in this application, deep speech recognition and understanding on the to-be-processed speech data can be implemented, thereby improving accuracy of the speech recognition.

### BRIEF DESCRIPTION OF THE DRAWINGS

FIG. 1 is a schematic diagram of a network architecture of a speech processing system according to an embodiment of this application.

FIG. 2 is a schematic diagram of an application scenario of a speech processing method according to an embodiment of this application.

FIG. 3 is a schematic flowchart of a speech processing method according to an embodiment of this application.

FIG. 4 is a schematic diagram of an architecture of a speech feature extraction model according to an embodiment of this application.

FIG. 5 is a schematic flowchart of a training method of a speech feature extraction model according to an embodiment of this application.

FIG. 6 is a schematic flowchart of a training method of a speech conversion model according to an embodiment of this application.

FIG. 7 is a schematic diagram of a parameter adjustment in a speech conversion model according to an embodiment of this application.

FIG. 8 is a schematic diagram of a composition structure of a speech processing apparatus according to an embodiment of this application.

FIG. 9 is a schematic diagram of a composition structure of a computer device according to an embodiment of this application.

### DESCRIPTION OF EMBODIMENTS

In some speech processing tasks, when speech recognition and speech understanding are performed, the speech recognition is performed on speech data to obtain text data, and text processing is performed on the text data to implement the speech understanding. Because the speech understanding is performed based on the text data obtained through the speech recognition, and the text data includes only text content, understanding only can be performed based on the text content during the speech understanding, and paralinguistic information included in the speech data cannot be used. For example, the paralinguistic information may be hidden information hidden in the speech data, such as an emotion, an expression, or an intonation. Therefore, in a complex scenario, when a speech recognition effect is relatively poor, a speech recognition result is used as a precondition for speech understanding, leading to error accumulation in speech understanding. Error correction cannot be performed, resulting in low accuracy of speech recognition.

In view of this, this application provides a speech processing solution, applicable to any speech interaction scenarios such as a conference scenario, an interview scenario, an intelligent conversation scenario, and a game scenario. The speech data can be converted into the text information in the speech interaction scenarios, thereby improving accuracy of speech recognition, and facilitating a related service processing operation in the speech interaction scenarios. Specifically, in the speech processing solution, the speech data is not directly recognized as the text data for understanding the text data. Instead, speech representation information including a speech content vector and a paralinguistic vector in the speech data is extracted, and the speech content vector, the paralinguistic vector, and a prompt word are further processed to obtain final text information. Because the paralinguistic information is included in the speech data, speech understanding is performed on the speech data in combination with the paralinguistic information, so that accuracy of the speech understanding can be improved. Specifically, a principle of the speech processing solution is approximately as follows:
(1) Obtain to-be-processed speech data in a service scenario, where the service scenario herein includes, but is not limited to, any speech interaction scenarios such as a conference scenario, an interview scenario, an intelligent conversation scenario, and a game scenario. The to-be-processed speech data may be generated by any object in the service scenario, for example, a conference master in the conference scenario, or a game-controlled object or a game role in the game scenario.
(2) Perform feature extraction on the to-be-processed speech data to obtain target speech representation information of the to-be-processed speech data, where the target speech representation information includes a speech content vector and a paralinguistic vector that correspond to the to-be-processed speech data, and the paralinguistic vector is configured for assisting in recognizing text information corresponding to the to-be-processed speech data.
(3) Obtain a prompt word about the to-be-processed speech data, and perform fusion processing on the speech content vector, the paralinguistic vector, and the prompt word, to obtain a speech fusion feature; and perform speech conversion processing on the to-be-processed speech data according to the speech fusion feature, to obtain the text information corresponding to the to-be-processed speech data.

In this embodiment of this application, the target speech representation information includes the speech content vector and the paralinguistic vector that correspond to the to-be-processed speech data, and the paralinguistic vector is configured for assisting recognizing the text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word. Because more comprehensive and abundant speech representation information is used, in this application, deep speech recognition and understanding on the to-be-processed speech data can be implemented, thereby improving accuracy of the speech recognition.

The technical solution of this application may be applied to a scenario in which speech data is converted into text information through speech recognition. For example, the technical solution may be applied to speech transcription in an online conference scenario, speech input in a social application scenario, speech to text in a recording device in an interview scenario, and speech conversation in an intelligent conversation scenario, and another scenario. For example, in the online conference scenario, speech data is obtained by recording speeches in the conference, and speech transcription is performed on the speech data to obtain a corresponding conference minute, so that efficiency of obtaining focused content of the conference can be improved. For another example, in a social application, speech data of a user is obtained, and speech recognition is performed to obtain text information, so that efficiency of inputting the text information can be improved. For another example, in the interview scenario, speech data recorded by a recording device is recognized and converted into text, so that efficiency of obtaining interview text can be improved. For another example, in the intelligent conversation scenario, speech recognition is performed on speech data of a dialogist to obtain text information, so that accurate text conversation can be implemented. In some embodiments, the technical solution of this application may be applied to various scenarios, including but not limited to a cloud technology, artificial intelligence, intelligent transportation, assisted driving, and the like.

In embodiments of this application, data (for example, the to-be-processed speech data, a sample speech data, and a prompt word) related to object information is involved. When embodiments of this application are applied to a specific product or technology, user permission or consent needs to be obtained, and collection, use, and processing of related data need to comply with related laws, regulations, and standards in related countries and regions. For example, the object may be a user of a terminal device or a computer device.

The following describes an architecture of a system in detail according to embodiments of this application.

FIG. 1 is a schematic diagram of a network architecture of a speech processing system according to an embodiment of this application. As shown in FIG. 1, a computer device may exchange data with a terminal device, and a quantity of terminal devices may be one or at least two. For example, when there are a plurality of terminal devices, the terminal devices may include a terminal device 101a, a terminal device 101b, a terminal device 101c, and the like in FIG. 1. The terminal device 101a is used as an example. The computer device 102 may perform feature extraction on to-be-processed speech data to obtain target speech representation information of the to-be-processed speech data. Further, the computer device 102 may obtain a prompt word about the to-be-processed speech data, and perform fusion processing on a speech content vector, a paralinguistic vector, and the prompt word, to obtain a speech fusion feature. Further, the computer device 102 may further perform speech conversion processing on the to-be-processed speech data according to the speech fusion feature, to obtain the text information corresponding to the to-be-processed speech data. In some embodiments, the computer device 102 may send the text information corresponding to the to-be-processed speech data to the terminal device 101a, to display text data on the terminal device 101a. Alternatively, the computer device 102 may determine reply text information based on the text information corresponding to the to-be-processed speech data, and send the reply text information to the terminal device 101a.

The computer device mentioned in this embodiment of this application includes, but is not limited to, a terminal device or a server. In other words, the computer device may be a server or a terminal device, or may be a system including the server and the terminal device. The terminal device mentioned above may be an electronic device, including, but not limited to, a mobile phone, a tablet computer, a desktop computer, a notebook computer, a palmtop computer, an on-board device, an intelligent speech interaction device, an augmented reality/virtual reality (AR/VR) device, a helmet display, a wearable device, a smart speaker, smart home appliances, an aircraft, a digital camera, a camera, and another mobile internet device (MID) with a network access capability. The server mentioned above may be an independent physical server, a server cluster or distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, vehicle infrastructure cooperation, a content delivery network (CDN), and a big data and artificial intelligence platform.

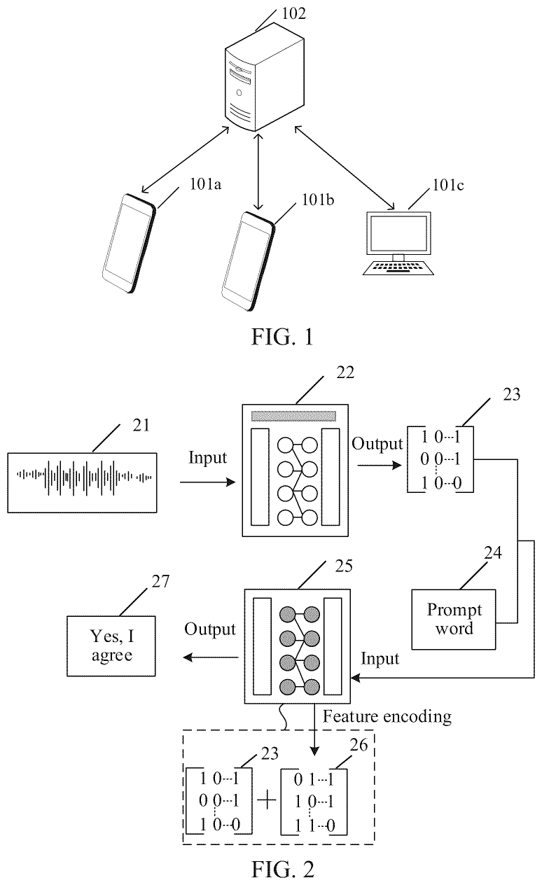

FIG. 2 is a schematic diagram of an application scenario of a speech processing method according to an embodiment of this application. As shown in FIG. 2, to-be-processed speech data 21 may be input into a speech feature extraction model 22. Feature encoding is performed on the to-be-processed speech data 21 by using the speech feature extraction model 22, to obtain a speech vector matrix of the to-be-processed speech data 21. For example, the to-be-processed speech data 21 is “Mm, right. Mhm, I agree. Yeah”. Feature conversion is performed on the speech vector matrix of the to-be-processed speech data 21 by using a speech representation full connection layer in the speech feature extraction model 22, to obtain target speech representation information 23 of the to-be-processed speech data 21. The target speech representation information includes a speech content vector and a paralinguistic vector that correspond to the to-be-processed speech data 21. Further, a prompt word 24 (for example, the prompt word is a de-colloquialized prompt word) about the to-be-processed speech data 21 is obtained; the target speech representation information 23 (that is, the speech content vector and the paralinguistic vector) and the prompt word 24 are inputted into a speech conversion model 25; feature processing such as feature encoding is performed on the prompt word 24 by using the speech conversion model 25, to obtain an eigenvector matrix 26 corresponding to the prompt word 24; and fusion processing is performed on the eigenvector matrix 26 corresponding to the prompt word and the target speech representation information 23 of the to-be-processed speech data 21 by using the speech conversion model 25, to obtain a speech fusion feature. The speech conversion model 25 may convert the speech fusion feature into text information 27 corresponding to the to-be-processed speech data 21. Finally, the text information 27 is outputted. For example, a de-colloquialized text information 27 is “Yes, I agree”.

Based on this, in the foregoing application scenario, the target speech representation information includes the speech content vector and the paralinguistic vector that correspond to the to-be-processed speech data, and the paralinguistic vector is configured for assisting in recognizing text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word, so that deep speech recognition and understanding on the to-be-processed speech data can be implemented, thereby improving accuracy of the speech recognition.

Specific embodiments of this application are described in detail in the following.

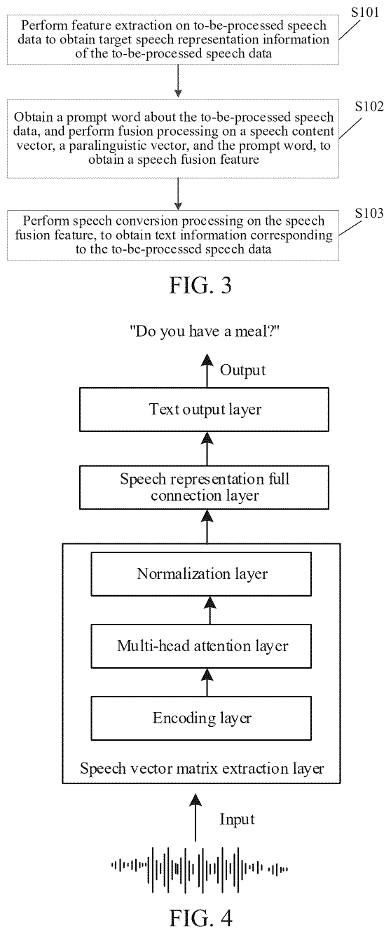

FIG. 3 is a schematic flowchart of a speech processing method according to an embodiment of this application. As shown in FIG. 3, the speech processing method may be applied to a computer device. The speech processing method includes but is not limited to the following operations S101 to S103.

S101: Perform feature extraction on to-be-processed speech data to obtain target speech representation information of the to-be-processed speech data.

Specifically, a manner for obtaining the to-be-processed speech data includes any one of the following manners.

Manner 1: Speech data is collected from a service scenario in real time as the to-be-processed speech data. In a possible implementation, the speech data may be collected in real time from the service scenario (for example, any type of service scenarios such as a conference scenario, an interview scenario, an intelligent conversation scenario, and a game scenario). For example, game speech data is obtained from the game scenario by using a recording apparatus (for example, a microphone of a mobile phone). For another example, conference speech data is obtained from the conference scenario by using a recording apparatus (for example, a microphone of a mobile phone), and so on. Moreover, the collected speech data is used as the to-be-processed speech data. In some embodiments, after the speech data is collected in real time, preprocessing may be performed on the speech data collected in real time, and the preprocessed speech data is used as the to-be-processed speech data. The preprocessing operation herein includes, but is not limited to, processing manners such as speech denoising, speech alignment, and data normalization. The preprocessed speech data is more accurate. In this implementation, speech data that can be collected in real time in the service scenario is used as the to-be-processed speech data. Such a real-time data collection manner has good real-time performance, facilitating timely data processing.

Manner 2: Collected speech data is obtained from a preset database as the to-be-processed speech data. In a possible implementation, the preset database stores speech data that has been collected from various types of service scenarios. Different types of service scenarios and corresponding speech data are associated for storage. For example, game speech data is stored in a game scenario. For another example, conference speech data is stored in a conference scenario. Therefore, the collected speech data in any service scenario may be directly obtained from the preset database based on a service requirement as the to-be-processed speech data. In this implementation, the to-be-processed speech data can be directly obtained from the preset database without real-time collection, thereby improving efficiency of data obtaining.

The target speech representation information includes a speech content vector and a paralinguistic vector that correspond to the to-be-processed speech data. Specifically, (1) the speech content vector can reflect speech content in the to-be-processed speech data. For example, the speech content may refer to specific content included in a speech frame corresponding to each word in the to-be-processed speech data. For example, if the to-be-processed speech data is “Do you have a meal?”, the to-be-processed speech data includes words: “Do”, “you”, “have”, “a meal”, and “?”. Further, the speech content refers to a speech obtained through pronunciation on the foregoing words, for example, “Do”, “you”, “have”, “a meal”, and “?”. (2) The paralinguistic vector is configured for assisting recognizing text information corresponding to the to-be-processed speech data. The paralinguistic vector may reflect paralinguistic information in the to-be-processed data, and the so-called paralinguistic information may be configured for assisting recognizing the to-be-processed speech data. The paralinguistic information, for example, may include information such as volume, timbre, and speed of pronunciation of each word in the to-be-processed speech data, or may further include corresponding emotion information during pronunciation. The paralinguistic information is data configured for reflecting hidden information such as emotion and intonation in the to-be-processed speech data. The hidden information is information that cannot be directly found intuitively from a data surface.

The paralinguistic vector and the speech content vector in the to-be-processed speech data are both vectors corresponding to information in speech modalities, and the information of the two speech modalities, paralinguistic information and speech content, are difficult to separate. However, directly converting the to-be-processed speech data into text data can only convert the speech content into text data, and cannot convert the paralinguistic information into text data. In addition, because the text data obtained through conversion includes only words, information such as an emotion of a speaker when the speaker speaks the word and volume of the speaker cannot be reflected in the text data. In this embodiment of this application, because the paralinguistic information in the speech data represents the information of the speaker in a speech manner, information such as speaking content of the speaker can be completely expressed by using the speech content and the paralinguistic information.

A specific process of how to extract target speech representation information of the to-be-processed speech data is described in detail below.

Manner 1: The target speech representation information of the to-be-processed speech data is extracted by using a prompt word.

In an embodiment, a process of extracting the target speech representation information of the to-be-processed speech data includes following operations (1) to (3).
(1) Obtain a feature conversion parameter configured for performing feature conversion on the prompt word, where a feature conversion parameter may be configured for performing feature conversion on the prompt word, to obtain an eigenvector matrix corresponding to the prompt word.
(2) Perform feature encoding on the to-be-processed speech data, to obtain a speech vector matrix of the to-be-processed speech data, where feature encoding is performed on the to-be-processed speech data, so that each word in the to-be-processed speech data can be encoded into a speech vector. Performing feature encoding on the to-be-processed speech data refers to embedding and encoding a speech signal into a vector space of a fixed dimension, to obtain the speech vector. Because the to-be-processed speech data includes a plurality of words, the to-be-processed speech data may be encoded into a plurality of speech vectors corresponding to the plurality of words, to obtain the speech vector matrix, so as to obtain the speech vector matrix corresponding to the to-be-processed speech data. For example, a dimension of a speech vector obtained through feature encoding on a word is m dimensions, and feature encoding is performed on the to-be-processed speech data including n words to obtain an m*n-dimensional matrix. In other words, the speech vector matrix may be an m*n-dimensional matrix.

In an embodiment, a process of obtaining the speech vector matrix of the to-be-processed speech data may include the following operations \textcircled{1} and \textcircled{2}:
\textcircled{1}: Divide the to-be-processed speech data to obtain N audio frames (where N is a positive integer). For example, when the to-be-processed speech data is obtained, framing processing may be performed on the to-be-processed speech data, to obtain the N audio frames. The framing processing may refer to dividing the to-be-processed speech data based on frame lengths, to obtain the N audio frames. For example, the frame length may be any value, for example, may range from 10 milliseconds to 30 milliseconds. Generally, one word in speech content of a to-be-processed speech signal may correspond to N audio frames. For example, an example in which a speech signal corresponding to one word in the speech content is one second and a frame length is 30 milliseconds, a quantity of audio frames corresponding to the word is approximately 33.
\textcircled{2}: Perform feature encoding on each audio frame, to obtain a speech vector matrix of each audio frame. Feature encoding herein is to convert an audio frame from speech data into a feature vector. The speech data is converted into the speech vector matrix, to facilitate subsequent calculation. In an exemplary implementation, feature encoding may be performed in combination with a position feature of each audio frame, to obtain the speech vector matrix of the audio frame. For example, the position feature of each audio frame may be determined based on a division sequence of the N audio frames, where the position feature indicates a position of a corresponding audio frame in the to-be-processed speech data; feature encoding is performed on each audio frame, to obtain an encoding feature of each audio frame; for an audio frame i in the N audio frames, feature splicing is performed on a position feature of the audio frame i and an encoding feature of the audio frame i, to obtain a speech vector matrix of the audio frame i. The position feature of each audio frame may indicate a position of each audio frame in the to-be-processed speech data. Because the to-be-processed speech data is usually divided based on a chronological sequence of pronunciation in the to-be-processed speech data, an audio frame corresponding to speech data that is earlier in pronunciation in the to-be-processed speech data is divided as an earlier sequence, and an audio frame corresponding to speech data that is later in pronunciation in the to-be-processed speech data is divided as a later sequence. Therefore, the position feature of each audio frame may be determined based on a division sequence of the N audio frames. Further, when splicing processing is performed on the encoding feature of the N audio frames, feature splicing may be performed on each audio frame in combination with the position feature of each audio frame, to obtain speech vector matrices of the N audio frames. The position feature is introduced during feature encoding. Subsequently, when slicing processing is performed on the encoding feature of the audio frames, the slicing processing may be performed in combination with the position feature of the audio frame, thereby ensuring accuracy of a word sequence in text information, and making a speech recognition result more accurate.

In this embodiment of this application, if a probability that a currently traversed audio frame is mapped to a word in the speech content is largest and is greater than a probability threshold, it indicates that the currently traversed audio frame can be mapped to the word in the speech content. If a maximum probability in the probabilities that the currently traversed audio frame is mapped to words in the speech content is less than the probability threshold, it indicates that the currently traversed audio frame cannot be mapped to each word in the speech content. In other words, there is less speech information in the audio frame. Therefore, candidate speech representation information of the currently traversed audio frame may be deleted from candidate speech representation information of the N audio frames. The candidate speech representation information of traversed audio frame of which a probability that the traversed audio frame is mapped to each word in the speech content of the to-be-processed speech data is less than the probability threshold is deleted from the N audio frames. After the traversal is ended, the target speech representation information of the to-be-processed speech data may be obtained based on remaining candidate speech representation information. For example, the remaining candidate speech representation information may be spliced or combined to obtain the target speech representation information of the to-be-processed speech data.

In this embodiment of this application, the probability may be, for example, a posterior probability outputted by using a speech feature extraction model. When a probability corresponding to an audio frame is less than the probability threshold, the audio frame corresponding to the probability may be omitted. The to-be-processed speech data is divided into the N audio frames, and speech data corresponding to each word includes N audio frames. Therefore, there is an audio frame with less speech information in the N audio frames corresponding to one word, and deleting the audio frame with less speech information in these audio frames has little impact on an entire speech recognition result. Therefore, the audio frame with less information may be deleted from the to-be-processed speech data, so that a calculation amount can be reduced, to improve efficiency of calculation.
(3) Perform feature conversion on the speech vector matrix of the to-be-processed speech data by using the feature conversion parameter, to obtain the target speech representation information of the to-be-processed speech data, where a dimension of an eigenvector matrix represented by the target speech representation information is the same as a dimension of the eigenvector matrix corresponding to the prompt word. An objective of performing feature conversion on the speech vector matrix of the to-be-processed speech data by using the feature conversion parameter is to cause a dimension of the speech vector matrix of the to-be-processed speech data the same as the dimension of the eigenvector matrix corresponding to the prompt word, so that the speech vector matrix of the to-be-processed speech data and the eigenvector matrix corresponding to the prompt word can be subsequently spliced.

In an embodiment, when feature conversion is performed on the speech vector matrix of the to-be-processed speech data, to obtain the target speech representation information of the to-be-processed speech data, meaningless audio frames in the to-be-processed speech data may be further removed, thereby reducing a calculation amount. Specifically, feature conversion may be performed on the speech vector matrix of each audio frame by using the feature conversion parameter, to obtain the candidate speech representation information of each audio frame. N audio frames are traversed, and probabilities that the currently traversed audio frame is mapped to words in the speech content are predicted based on the candidate speech representation information of the currently traversed audio frame. The speech content is content indicated by the speech content vector. The candidate speech representation information of the currently traversed audio frame is deleted from the candidate speech representation information of each audio frame if a maximum probability in the probabilities that the currently traversed audio frame is mapped to the words in the speech content is less than the probability threshold. After the traversal is ended, the target speech representation information of the to-be-processed speech data is obtained based on the remaining candidate speech representation information. In this embodiment, the N audio frames of the to-be-processed speech data are traversed, so that probabilities that the N audio frames are mapped to words in the speech content of the to-be-processed speech data may be predicted based on the candidate speech representation information of the N audio frames. The probability that each audio frame is mapped to each word in the speech content of the to-be-processed speech data may reflect a probability that each audio frame is mapped to each word in the speech content of the to-be-processed speech data. In other words, a larger probability indicates a larger probability that the word corresponding to the audio frame is each word in the speech content of the to-be-processed speech data, and a smaller probability indicates a smaller probability that the audio frame is each word in the speech content of the to-be-processed speech data. That the audio frame corresponds to a word may be an audio frame obtained by pronouncing the word. If the probability that the audio frame is mapped to each word in the speech content of the to-be-processed speech data is less than the probability threshold, it indicates that the audio frame is a meaningless audio frame, that is, the audio frame includes less speech information. Therefore, to accelerate efficiency of calculation, the meaningless audio frame may be omitted.

It can be learned from the foregoing operations (1) to (3) that in a process of extracting the target speech representation information, because the dimension of the eigenvector matrix represented by the target speech representation information is the same as the dimension of the eigenvector matrix corresponding to the prompt word, and the target speech representation information includes the speech content vector and the paralinguistic vector, in this application, an essence for performing fusion processing on the target speech representation information and the eigenvector matrix corresponding to the prompt word is to perform fusion processing on the speech content vector, the paralinguistic vector, and the prompt word. Feature conversion is performed on the speech vector matrix of the to-be-processed speech data by using the feature conversion parameter to obtain the target speech representation information of the to-be-processed speech data, so as to facilitate subsequent better fusion of the speech representation information and the text information corresponding to the prompt word, thereby improving accuracy of speech recognition.

Manner 2: A trained speech feature extraction model is used to extract the target speech representation information of the to-be-processed speech data.

Specifically, the trained speech feature extraction model may be used to perform feature extraction, thereby improving efficiency of feature extraction. For example, the speech feature extraction model may include, but is not limited to, an automatic speech recognition (ASR) model, a transform model based on a self-attention mechanism, a convolution augmented transform model, a connectionist temporal classification (CTC) model based on a neural network, and the like. In some embodiments, the speech feature extraction model may include a speech vector matrix extraction layer and a speech representation full connection layer. The speech vector matrix extraction layer may be configured to extract a speech vector matrix of the to-be-processed speech data. The speech representation full connection layer may be configured to convert the speech vector matrix of the to-be-processed speech data into the target speech representation information of the to-be-processed speech data.

For example, FIG. 4 is a schematic diagram of an architecture of a speech feature extraction model according to an embodiment of this application. The speech feature extraction model may include a speech vector matrix extraction layer and a speech representation full connection layer. The speech vector matrix extraction layer may be configured to output a speech vector matrix of to-be-processed speech data. The speech representation full connection layer may be configured to output target speech representation information of the to-be-processed speech data. Further, in some embodiments, the speech vector matrix extraction layer may further include an encoding layer, a multi-head attention layer, and a normalization layer. Specifically, the to-be-processed speech data is inputted into the speech feature extraction model, and the to-be-processed speech data is processed by the speech vector matrix extraction layer in the speech feature extraction model. For example, each audio frame in the to-be-processed speech data may be encoded by using the encoding layer in the speech vector matrix extraction layer, to obtain encoding features. A position feature of each audio frame in the to-be-processed speech data is obtained by using the encoding layer. The encoding feature and the position feature of each audio frame are spliced, to obtain a spliced encoding feature of each audio frame. The spliced encoding feature is a speech vector with position information. Similarities between spliced encoding features of audio frames are calculated by using the multi-head attention layer, to determine a similarity score between every two audio frames. Similarity scores are normalized to be in a range of 0 to 1 by using the normalization layer. For every two audio frames, a higher similarity score between two audio frames indicates a larger weight between the two audio frames, and a lower similarity score between two audio frames indicates a smaller weight between the two audio frames. Weighted summation is performed on each audio frame and other audio frames in combination with weights between audio frames, so that an obtained audio frame includes speech information of the audio frame itself and further includes speech information of other audio frames. In other words, context speech information in the to-be-processed speech data is introduced, so that every audio frame includes information about the entire to-be-processed speech data. A matrix with a dimension same as that of the spliced encoding feature, that is, the speech vector matrix of the to-be-processed speech data, is outputted by using the normalization layer. Further, a feature conversion parameter in the speech representation full connection layer may be fixed in advance. Therefore, the speech vector matrix of the to-be-processed speech data is converted by using the feature conversion parameter in the speech representation full connection layer, to output the target speech representation information of the to-be-processed speech data.

In some embodiments, the speech feature extraction model may further include a text output layer. The target speech representation information of each audio frame in the to-be-processed speech data is inputted to the text output layer. The text output layer may predict a probability that the target speech representation information of each audio frame in the to-be-processed speech data is mapped to each word in speech content of the to-be-processed speech data, that is, predict a probability that the target speech representation information of each audio frame is a plurality of words, to determine text data corresponding to the to-be-processed speech data, and output the text data, for example, “do you have a meal?”.

For example, when the speech feature extraction model is an ASR model, a full connection layer previous to the CTC full connection layer may be determined as the speech representation full connection layer. For example, a feature conversion parameter may be obtained, an original parameter in the full connection layer is replaced with the feature conversion parameter, and a full connection layer on which a parameter is replaced is referred to as the speech representation full connection layer A function of the speech representation full connection layer is to perform parameter sharing with the feature conversion parameter configured for performing conversion processing on the prompt word, to align hidden space representation distribution of speech and text, thereby implementing subsequent information fusion between two different modalities, namely, the speech and the text.

S102: Obtain a prompt word about the to-be-processed speech data, and perform fusion processing on the speech content vector, the paralinguistic vector, and the prompt word, to obtain a speech fusion feature.

In this embodiment of this application, the prompt word about the to-be-processed speech data is obtained, and fusion processing is performed on the speech content vector, the paralinguistic vector, and the prompt word, to obtain the speech fusion feature. The speech fusion feature includes the prompt word of the to-be-processed speech data, and includes speech content and paralinguistic information. Therefore, text information obtained subsequently by performing processing on the speech fusion feature can reflect the speech content of the to-be-processed speech data, reflect the paralinguistic information in the to-be-processed speech data, and can further reflect text content corresponding to the prompt word, so that deep speech understanding on the speech data can be implemented, thereby improving accuracy of speech recognition. Because the target speech representation information includes the speech content vector and the paralinguistic vector, an essence for performing fusion processing on the speech content vector, the paralinguistic vector, and the prompt word is to perform fusion processing on the target speech representation information and the prompt word.

In an embodiment, the prompt word about the to-be-processed speech data may be obtained by using the following manner: outputting a plurality of preset prompt words by using a display interface, where in response to a selection operation on the display interface, the selection operation includes the prompt word; and selecting, based on the selection operation, the prompt word about the to-be-processed speech data from the plurality of preset prompt words outputted by the display interface. The prompt word may be configured for reflecting a speech understanding manner of the to-be-processed speech data. The prompt word may include, but is not limited to, a re-recognition prompt word, an emotion recognition prompt word, a de-colloquialized prompt word, a punctuation addition prompt word, a text smoothing prompt word, an error correction prompt word, and the like. An emotion category may include, but is not limited to, categories such as cheering, sadness, fear, anger, surprise, and disgust. The error correction prompt word may include technical terms in various fields. The prompt word about the to-be-processed speech data is selected, and subsequently, and corresponding text information may be outputted in combination with the prompt word.

For example, if the selected prompt word is the re-recognition prompt word, re-recognition may be performed on the to-be-processed speech data, and text information obtained through re-recognition on the to-be-processed speech data is outputted. Alternatively, if the selected prompt word is the emotion recognition prompt word, the outputted text information may include an emotion category corresponding to the to-be-processed speech data, that is, an emotion category of a speaker when speaking, and the text information corresponding to the to-be-processed speech data may be outputted at the same time. Alternatively, if the selected prompt word is the de-colloquialized prompt word, the outputted text information may be text information obtained by de-colloquializing the to-be-processed speech data. Alternatively, if the selected prompt word is the punctuation addition prompt word, the outputted text information may be text information in which punctuations are added to the text content corresponding to the to-be-processed speech data. Alternatively, if the selected prompt word is the text smoothing prompt word, the outputted text information may be text information obtained by performing text smoothing processing on the to-be-processed speech data, that is, the text information is smoother. Alternatively, if the selected prompt word is the error correction prompt word, the outputted text information may be text information obtained by performing text error correction on the text content corresponding to the to-be-processed speech data.

In an exemplary implementation, the prompt word corresponding to the to-be-processed speech data may be selected, so that text information corresponding to the selected prompt word may be outputted based on the obtained target speech representation information of the to-be-processed speech data. For example, if the selected prompt word is the re-recognition prompt word, the text information may be outputted based on the obtained target speech representation information of the to-be-processed speech data, and the outputted text information is as smooth and coherent as possible. For example, if the selected prompt word is the emotion recognition prompt word, the emotion category of the speaker may be determined based on the obtained target speech representation information of the to-be-processed speech data, the emotion category corresponding to the to-be-processed speech data is selected from the following plurality of emotion categories (such as cheering, sadness, fear, anger, surprise, and disgust) based on the emotion category of the speaker, and the selected emotion category is outputted. For example, if the selected prompt word is the de-colloquialized prompt word, the text information may be obtained based on the obtained target speech representation information of the to-be-processed speech data, and a colloquialized word in the text information is removed, so that the text information is as smooth and easy-to-read as possible, to output text information from which the colloquialized word in the text information is removed. For example, if the selected prompt word is the punctuation addition prompt word, the text information may be obtained based on the obtained target speech representation information of the to-be-processed speech data, and the text information added with punctuation points is outputted after punctuation points are added to the text information.

In this embodiment of this application, the prompt word is selected according to a requirement corresponding to the to-be-processed speech data, so that speech understanding can be performed while the to-be-processed speech data is recognized, thereby improving accuracy of speech recognition, and obtaining more accurate text information.

In an embodiment, fusion processing may be performed on the prompt word and the target speech representation information in the following manner: performing feature conversion on the prompt word by using the feature conversion parameter, to obtain the eigenvector matrix corresponding to the prompt word; and performing feature splicing on the speech content vector, the paralinguistic vector, and the eigenvector matrix corresponding to the prompt word, to obtain the speech fusion feature.

An essence for performing feature splicing on the speech content vector, the paralinguistic vector, and the eigenvector matrix corresponding to the prompt word is to perform feature splicing on the target speech representation information and the eigenvector matrix corresponding to the prompt word. The speech fusion features obtained by using the two splicing methods are the same. Because a dimension of the eigenvector matrix corresponding to the prompt word is the same as a dimension of the eigenvector matrix represented by the target speech representation information, feature splicing may be performed on the eigenvector matrix corresponding to the target speech representation information and the eigenvector matrix corresponding to the prompt word, to obtain the speech fusion feature. The speech fusion feature can reflect speech content of the to-be-processed speech data, can reflect the paralinguistic information in the to-be-processed speech data, and can further reflect the text content corresponding to the prompt word. Therefore, the text information obtained subsequently through processing on the speech fusion feature can include the speech content of the to-be-processed speech data, can reflect the paralinguistic information in the to-be-processed speech data, and can further reflect text content corresponding to the prompt word, thereby improving accuracy of speech recognition.

In some embodiments, the feature conversion parameter may be a parameter of a word embedding layer. The word embedding layer may perform feature conversion on inputted text data such as the prompt word, to convert the text data into the eigenvector matrix. An essence for performing feature conversion on the prompt word by using the parameter in the word embedding layer is to perform feature encoding, that is, encode data of a text dimension into a feature vector. Word embedding refers to a process of encoding a divided word into a dense vector, that is, mapping the word to mathematical space. For example, a parameter of the word embedding layer, that is, the feature conversion parameter, may be preset. The parameter of the word embedding layer, that is, the feature conversion parameter may convert the prompt word into the eigenvector matrix by inputting the prompt word into the word embedding layer. Feature conversion is performed on the prompt word by using the word embedding layer, to facilitate subsequent use of the eigenvector matrix to perform feature fusion and speech understanding, thereby improving accuracy of speech recognition.

In this embodiment of this application, the to-be-processed speech data is converted into speech representation information of which a dimension is equal to that of the eigenvector matrix corresponding to the prompt word, so that the speech representation information and text semantic alignment can be implemented. In other words, hidden space representation of speech of the to-be-processed speech data is consistent with hidden space representation of text corresponding to the to-be-processed speech data. Therefore, the speech representation information and the text semantic information can be fused, thereby improving accuracy of speech recognition.

S103: Perform speech conversion processing on the to-be-processed speech data according to the speech fusion feature, to obtain the text information corresponding to the to-be-processed speech data.

In this embodiment of this application, because the speech fusion feature includes the text content corresponding to the prompt word, and the speech content and the paralinguistic information of the to-be-processed speech data, speech conversion processing is performed on the speech fusion feature, to obtain the text information corresponding to the to-be-processed speech data. The text information corresponding to the to-be-processed speech data may include the speech content of the to-be-processed speech data, may reflect the paralinguistic information in the to-be-processed speech data, and may further reflect the text content corresponding to the prompt word, so that deep speech understanding can be implemented, thereby improving accuracy of speech recognition.

In some embodiments, speech conversion processing may be performed on the speech fusion feature by using a trained speech conversion model, to obtain the text information corresponding to the to-be-processed speech data. For example, the speech conversion model may include, but is not limited to, a large language model (LLM), a chat general language model (GLM), an open source dialog language model (MOSS), a generative pre-training (GPT) model, and the like.

For example, a process of performing speech conversion processing on the to-be-processed speech data according to the speech fusion feature by using the trained speech conversion model to obtain the text information corresponding to the to-be-processed speech data may be as follows: dividing the speech fusion feature into a plurality of feature units; predicting a next feature unit based on an inputted feature unit sequence of the speech conversion model; adding the inputted feature unit and a predicted feature unit to the feature unit sequence; and continuing to predict a next feature unit, until a plurality of feature units corresponding to the speech fusion feature are predicted. Each time a feature unit is predicted, the feature unit and a feature unit previous to the feature unit are added to the feature unit sequence, to predict a next feature unit of the feature unit. The feature unit may refer to a basic unit of character, for example, may refer to a Chinese character, a word, or the like. In some embodiments, a byte pair encoding (BPE) method may also be used to divide a word into smaller units. For example, a subcharacter string or a character is used as a basic unit. In an exemplary implementation, a basic composition unit of text may be trained based on a text corpus, and used as the feature unit.

During specific implementation, because the eigenvector matrix represented by the target speech representation information is a multi-dimensional matrix, the eigenvector matrix corresponding to the prompt word is a multi-dimensional matrix, and dimensions of the two matrices are the same, the speech fusion feature obtained through fusion is also a multi-dimensional matrix, and dimensions of the three matrices are the same. When the multi-dimensional matrix corresponding to the speech fusion feature is inputted into the trained speech conversion model, a column of matrices in the multi-dimensional matrix corresponding to the speech fusion feature may be inputted as one feature unit. The column of matrices may include speech corresponding to one word in the to-be-processed speech data, so that a next column of feature units may be predicted. When the next column of feature units is predicted, the foregoing predicted feature unit is inputted into the speech conversion model as a feature unit sequence, so that the text information corresponding to the speech fusion feature is predicted.

In this embodiment of this application, because speech recognition is a perceptual task, a cognitive capability for speech data may be improved by combining the LLM model, thereby improving a capability of understanding the speech data in combination with speech modality information and text modality information, and enhancing performance in more tasks related to speech and semantic. Because the LLM model can deal with a text task in any form, a task related to speech and semantic can be extended in the technical solution of this application. For example, more modalities such as visual information may be further integrated based on the speech and the text. For example, the visual information may be converted into text representation information; and further be inputted, in combination with the text information and the speech representation information, to the LLM model for processing, thereby enriching speech understanding content and improving accuracy of speech recognition.

In embodiments of this application, feature extraction is performed on to-be-processed speech data to obtain target speech representation information of the to-be-processed speech data. A prompt word about the to-be-processed speech data is obtained, and fusion processing is performed on the target speech representation information and the prompt word, to obtain a speech fusion feature. Speech conversion processing is performed on the speech fusion feature, to obtain text information corresponding to the to-be-processed speech data. The target speech representation information includes a speech content vector and a paralinguistic vector that correspond to the to-be-processed speech data, and the paralinguistic vector is configured for assisting in recognizing the text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word. Because more comprehensive and abundant speech representation information is used for speech recognition processing, in this application, deep speech recognition and understanding on the to-be-processed speech data can be implemented, thereby improving accuracy of the speech recognition.

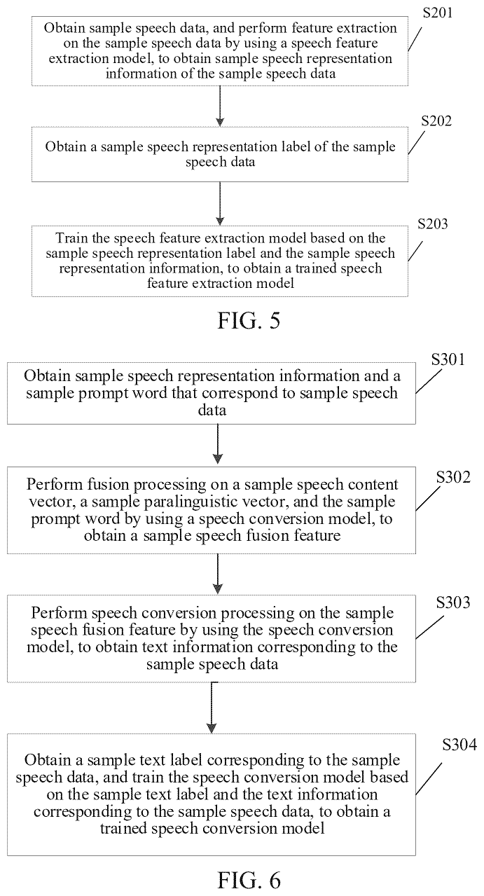

Further, FIG. 5 is a schematic flowchart of a training method of a speech feature extraction model according to an embodiment of this application. The method may be applied to a computer device. As shown in FIG. 5, the method includes but is not limited to the following operations.

S201: Obtain sample speech data, and perform feature extraction on the sample speech data by using a speech feature extraction model, to obtain sample speech representation information of the sample speech data.

In this embodiment of this application, the sample speech data may be pre-obtained, for example, may be downloaded from a speech data storage website, may be uploaded from a terminal device, or may be obtained from locally stored speech data. To increase the amount of training data, processing such as cutting, rotation, tone adjustment, and noise addition may be further performed on the sample speech data, thereby expanding the amount of sample speech data. A large amount of sample audio data is used as training data of the speech feature extraction model for training, so that accuracy of the speech feature extraction model can be improved.

In this embodiment of this application, for example, feature encoding may be performed on the sample speech data by using the speech feature extraction model, to obtain a speech vector matrix of the to-be-processed speech data; and feature conversion is performed on the speech vector matrix of the to-be-processed speech data by using a feature conversion parameter in the speech feature extraction model, to obtain the sample speech representation information of the sample speech data. The sample speech representation information of the sample speech data may include a sample speech content vector and a sample paralinguistic vector corresponding to the sample speech data.

In an embodiment, the speech feature extraction model may include a speech vector matrix extraction layer and a speech representation full connection layer. Therefore, the sample speech representation information of the sample speech data may be determined in combination with the speech vector matrix extraction layer and the speech representation full connection layer For example, the sample speech data may be inputted into the speech vector matrix extraction layer, and feature encoding is performed on the sample speech data by using the speech vector matrix extraction layer, to obtain a speech vector matrix of the sample speech data. The speech vector matrix of the sample speech data is inputted into the speech representation full connection layer Feature conversion is performed on the speech vector matrix of the sample speech data by using the feature conversion parameter in the speech representation full connection layer, to obtain the sample speech representation information of the sample speech data.

Further, in some embodiments, the speech vector matrix extraction layer may further include an encoding layer, a multi-head attention layer, and a normalization layer. Specifically, the sample speech data is inputted into the speech feature extraction model. The encoding layer encodes each audio frame in the sample speech data, to obtain encoding features. A position feature of each audio frame in the sample speech data is obtained, and the encoding feature and the position feature of each audio frame are spliced, to obtain a splicing encoding feature of each audio frame. The splicing encoding feature is a speech vector with the position information. Similarities between the spliced encoding features of audio frames in the sample speech data are calculated by using a multi-head attention layer, to determine a similarity score between every two audio frames. Similarity scores are normalized to be in a range of 0 to 1 by using a normalization layer. For every two audio frames in the sample speech data, a higher similarity score between two audio frames indicates a larger weight between the two audio frames, and a lower similarity score between two audio frames indicates a smaller weight between the two audio frames. Weighted summation is performed in combination with weights between each audio frame and other audio frames in the sample speech data, so that an obtained audio frame includes speech information of the audio frame itself and further includes speech information of other audio frames in the sample speech data. In this way, context speech information in the sample speech data is introduced, so that every audio frame in the sample speech data includes information about the entire sample speech data.

S202: Obtain a sample speech representation label of the sample speech data.

The sample speech representation label may be a pre-obtained speech representation label that is of a user and that reflects a true value of the sample speech data. The sample speech representation label of the sample speech data is obtained, and when the speech feature extraction model is subsequently trained, the speech feature extraction model may be adjusted in combination with the sample speech representation label and the sample speech representation information outputted by the speech feature extraction model.

S203: Train the speech feature extraction model based on the sample speech representation label and the sample speech representation information, to obtain a trained speech feature extraction model.

The sample speech representation information herein is a model output value of the speech feature extraction model, and the sample speech representation label is a sample true value. An objective of training the speech feature extraction model is to make the model output value consistent with the sample true value as much as possible. If the model output value is inconsistent with the sample true value, a model parameter in the speech feature extraction model continues to be adjusted to ensure that the model output value is consistent with the sample true value. When the model output value is consistent with the sample true value, the speech feature extraction model in this case is used as the trained speech feature extraction model.

The training the speech feature extraction model is: comparing a difference between the sample speech representation label and the sample speech representation information, and determining a loss function of the speech feature extraction model based on the difference between the sample speech representation label and the sample speech representation information. The difference between the sample speech representation label and the sample speech representation information may be calculated based on a similarity calculation method. In other words, a larger similarity between the sample speech representation label and the sample speech representation information indicates a smaller difference between the sample speech representation label and the sample speech representation information; and a smaller similarity between the sample speech representation label and the sample speech representation information indicates a larger difference between the sample speech representation label and the sample speech representation information. If the difference between the sample speech representation label and the sample speech representation information is greater than a difference threshold, the loss function of the speech feature extraction model is greater than a first loss threshold, and the model parameter of the speech feature extraction model continues to be adjusted, to reduce the loss function of the speech feature extraction model. When the difference between the sample speech representation label and the sample speech representation information is less than or equal to the difference threshold, the loss function of the speech feature extraction model is less than or equal to the first loss threshold, and the speech feature extraction model in this case may be stored as the trained speech feature extraction model.

In some embodiments, when a quantity of times of iterative training of the speech feature extraction model is greater than times threshold, or the speech feature extraction model reaches a convergence condition, the model parameter of the speech feature extraction model may be stopped to be adjusted, to obtain the trained speech feature extraction model.

In an exemplary implementation, the speech feature extraction model may be further trained in the following manner: performing feature extraction on the sample speech data by using the speech feature extraction model, to obtain the sample speech representation information of the sample speech data; predicting sample text data corresponding to the sample speech representation information of the sample speech data by using the speech feature extraction model; and obtaining a sample text label of the sample speech data, and training the speech feature extraction model based on the sample text label and the sample text data, to obtain the trained speech feature extraction model.

Predicting text data of the sample speech representation information of the sample speech data means to converting the sample speech representation information into information about a text modality, to train the speech feature extraction model based on a difference between two pieces of text. The sample text label may refer to true text of the sample speech data, and the text data of the sample speech representation information may refer to text predicted by the speech feature extraction model, that is, text outputted by the model. A difference between the sample text label and the text data of the sample speech representation information is compared, so that the speech feature extraction model is trained based on the difference between the sample text label and the text data of the sample speech representation information. The difference between the sample text label and the text data of the sample speech representation information may be calculated by using a text similarity calculation method. This is not limited in this embodiment of this application. The sample speech representation information is converted into the information about the text modality for comparison, so that text comparison may be performed, to determine a difference between text, thereby adjusting the speech feature extraction model.

In an embodiment, when the speech feature extraction model includes the speech vector matrix extraction layer and the speech representation full connection layer, the speech feature extraction model may be trained in the following manner:
adjusting a parameter of the speech vector matrix extraction layer based on the sample speech representation label and the sample speech representation information, to obtain the trained speech feature extraction model.

In this embodiment of this application, when the speech feature extraction model is trained, a parameter in the speech representation full connection layer is fixed, in other words, the parameter in the speech representation full connection layer is fixed as a feature conversion parameter of a word embedding layer. A parameter in the speech representation full connection layer is fixed, so that the speech feature extraction model can perform speech recognition, and hidden space representation of the speech feature extraction model is consistent with that of the speech conversion model, so as to input target speech representation information of the to-be-processed speech data outputted by the speech feature extraction model into the speech conversion model.

In an exemplary implementation, when the speech feature extraction model is trained, a meaningless frame may be separately deleted from the sample speech data, thereby reducing a calculation amount, and improving training efficiency of the speech feature extraction model.

In this embodiment of this application, the target speech representation information of the to-be-processed speech data is obtained by removing the meaningless frame from the to-be-processed speech data, thereby reducing the calculation amount. Weight sharing is performed on the speech representation full connection layer and a parameter of the word embedding layer in the speech conversion model, so that the speech representation information outputted by the speech representation full connection layer can be aligned with the encoding feature of the prompt word outputted by the word embedding layer, thereby implementing fusion between information in two modalities. The parameter of the speech representation full connection layer is from the word embedding layer in the speech conversion model.

In this embodiment of this application, the speech feature extraction model is trained, and feature extraction may be performed on the to-be-processed speech data by using the trained speech feature extraction model to obtain the target speech representation information of the to-be-processed speech data, thereby improving efficiency of speech data processing. Because a large amount of the sample speech data is used to train the speech feature extraction model, accuracy of the speech feature extraction model can be improved.

In some embodiments, FIG. 6 is a schematic flowchart of a training method of a speech conversion model according to an embodiment of this application. The method may be applied to a computer device. As shown in FIG. 6, the method includes but is not limited to the following operations.

S301: Obtain sample speech representation information and a sample prompt word that correspond to sample speech data.

In this embodiment of this application, the sample speech representation information may be obtained by performing feature extraction on the sample speech data. For example, the sample speech data may be divided to obtain N audio frames (where N is a positive integer); feature encoding is performed on the N audio frames in the sample speech data, to obtain a speech vector matrix of the N audio frames; feature conversion is performed on the speech vector matrix of the N audio frames by using a feature conversion parameter in a speech feature extraction model, to obtain candidate speech representation information of the N audio frames; and a meaningless audio frame is deleted from the candidate speech representation information of the N audio frames in sample audio data, to obtain the sample speech representation information. In this embodiment of this application, various sample prompt words may be included, and scenarios corresponding to the sample prompt words may be different. When training data is prepared, a corresponding sample prompt word may be selected according to an actual requirement. For example, the sample prompt word may include a text smoothing prompt word, a de-colloquialized prompt word, an error correction prompt word, a re-recognition prompt word, an emotion recognition prompt word, a punctuation addition prompt word, and another prompt word. For example, the error correction prompt word may include technical terms in various fields. The de-colloquialized prompt word may include some colloquialized words. The text smoothing prompt word may include a word formed by repeated words, and the like.

Because the prompt word does not have a fixed format, for example, the prompt word in a de-colloquialized scenario, an emotion recognition scenario, or the like is text, the prompt word in a punctuation addition scenario is a punctuation, or a prompt word in a re-recognition scenario is prompt information indicating re-recognition, in an actual use scenario, the selected prompt words only need to remain consistent with that in model training.

S302: Perform fusion processing on a sample speech content vector, a sample paralinguistic vector, and the sample prompt word by using the speech conversion model, to obtain a sample speech fusion feature.

Because the sample speech representation information of the sample speech data herein includes the sample speech content vector and the sample paralinguistic vector that correspond to the sample speech data, an essence for performing fusion processing on the sample speech content vector, the sample paralinguistic vector, and the sample prompt word is to perform fusion processing on the sample speech representation information and the sample prompt word. Because the speech representation information is represented by using an eigenvector matrix, and the prompt word is represented by using text, before fusion processing is performed on the speech representation information and the prompt word, the prompt word may be converted into an eigenvector matrix, to facilitate feature fusion, for example, feature splicing.

S303: Perform speech conversion processing on the sample speech data according to the sample speech fusion feature by using the speech conversion model, to obtain text information corresponding to the sample speech data.

For example, a process of performing speech conversion processing on the sample speech data according to the sample speech fusion feature by using the speech conversion model, to obtain the text information corresponding to the sample speech data may be as follows: dividing the sample speech fusion feature into a plurality of feature units; predicting a next feature unit based on an inputted feature unit sequence of the speech conversion model; adding the inputted feature unit and a predicted feature unit to the feature unit sequence; and continuing to predict a next feature unit, until a plurality of feature units corresponding to the sample speech fusion feature are predicted.

In an exemplary implementation, because an eigenvector matrix represented by the sample speech representation information is a multi-dimensional matrix, an eigenvector matrix corresponding to the sample prompt word is a multi-dimensional matrix, and dimensions of the two matrices are the same, the sample speech fusion feature obtained through fusion is also a multi-dimensional matrix, and dimensions of the three matrices are the same. When the multi-dimensional matrix corresponding to the sample speech fusion feature is inputted into a trained speech conversion model, a column of matrices in the multi-dimensional matrix corresponding to the sample speech fusion feature may be inputted as one feature unit. The column of matrices may include speech data corresponding to one word in the sample speech data, so that a next column of feature units may be predicted. When the next column of feature units is predicted, the foregoing predicted feature unit is inputted into the speech conversion model as a feature unit sequence, so that the text information corresponding to the sample speech fusion feature is predicted.

In some embodiments, for example, the speech conversion model may use a current open-source large language model, for example, a widely-used transformer structure-based model. An autoregressive form is used. That is, a next token is predicted based on an inputted token (a feature unit) sequence, then a next token is predicted based on an inputted and already predicted token, and so on, to predict the text information corresponding to to-be-processed speech data.

S304: Obtain a sample text label corresponding to the sample speech data, and train the speech conversion model based on the sample text label and the text information corresponding to the sample speech data, to obtain a trained speech conversion model.

In this embodiment of this application, the sample text label may be a real text label of the sample speech data, and the text information corresponding to the sample speech data may be a model output value that is outputted based on the speech conversion model. An objective of training the speech conversion model is to make the sample text label be as consistent as possible with the text information corresponding to the sample speech data. When the sample text label is consistent with the text information corresponding to the sample speech data, the speech conversion model in this case may be determined as the trained speech conversion model. The sample text label and the text information corresponding to the sample speech data may be calculated by using a text similarity calculating method.

Training the speech conversion model based on the sample text label and the text information corresponding to the sample speech data refers to: determining a loss function of the speech conversion model based on a difference between the sample text label and the text information corresponding to the sample speech data. When the loss function of the speech conversion model is greater than a second loss threshold, a model parameter of the speech conversion model continues to be adjusted, to reduce the loss function of the speech conversion model. When the loss function of the speech conversion model is less than or equal to the second loss threshold, the speech conversion model in this case is determined as the trained speech conversion model.

In some embodiments, a process of training the speech conversion model is essentially a process of adjusting a parameter in the speech conversion model. Because the speech conversion model includes a large quantity of parameters, and adjusting all parameters in the speech conversion model during training consumes a large amount of time, reducing efficiency of training, some parameters in the speech conversion model may be adjusted, to improve efficiency of speech conversion model.

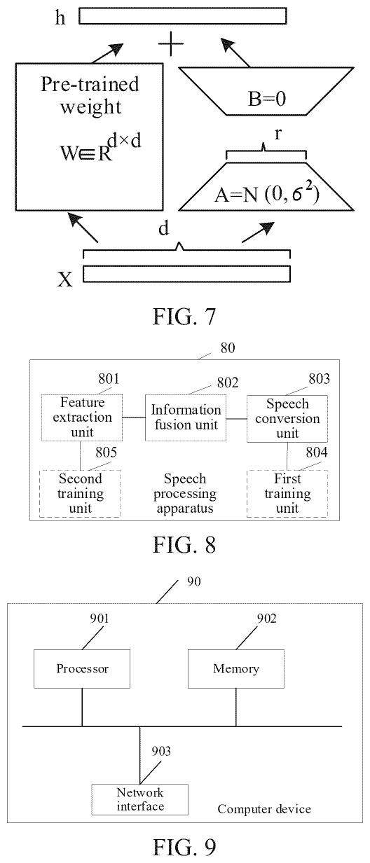

FIG. 7 is a schematic diagram of a parameter adjustment in a speech conversion model according to an embodiment of this application. The left part in FIG. 7 is a parameter W (that is, a pre-trained weight) in a pre-training model in the speech conversion model (for example, an LLM model). A branch is added beside a pre-trained model structure. The branch includes two structures A and B, and the two parameters A and B are respectively initialized to be Gaussian distribution and 0. At the beginning of training, an additional parameter is 0. An input dimension of A and an output dimension of B are respectively the same as an input/output dimension of an original model. However, an output dimension of A and an input dimension of B are values far less than the input/output dimension of the original model. In this way, to-be-trained parameters in the LLM model can be greatly reduced. During training of the LLM model, only parameters A and B are updated. The pre-trained model parameter W is fixed, and A and B are combined with the original model parameter matrix W. In this way, no additional calculation is introduced to inference. For different downstream tasks, A and B need to be trained again based on a pre-trained model. After a new parameter is trained, the new parameter is combined with an old parameter, and a reparameterization manner is used, so that a fine adjustment effect can be achieved on a new task without increasing time consumption in model inference, so that efficiency of model training can be improved. Because a quantity of parameters of the LLM model is large, during fine adjustment, only a small quantity of parameters are added for training, thereby improving efficiency of training.

When a speech conversion model is trained, the key of predicting output data of the speech conversion model based on data of the speech conversion model is preparation of a training set. For a given task (such as text smoothing, de-colloquialized, and error correction), the following training set may be prepared. Speech representation information of sample speech data and a prompt word corresponding to the sample speech data are both input into the speech conversion model after the sample speech data removes a meaningless frame by using the foregoing speech feature conversion model, so that text information of a corresponding task may be outputted.

Example 1 is a text smoothing scenario.
Input: Do you you have a meal (where the input is speech representation information in a speech modality)? Corresponding prompt words such as “you, you, I, and I” and other repeated words are added.
Output: Do you have a meal?

Example 2 is a de-colloquialized scenario.
Input: Mm, right. Mm, I agree. Yeah (where the input is speech representation information in a speech modality). Corresponding prompt words such as “Yeah, yes, yes, yes” and other colloquialized words are added.
Output: Yes, I agree.

Example 3 is an error correction scenario.
Input: An original factory effect of this system is not good (where the input is speech representation information in a speech modality). Corresponding prompt words such as “far field” and other technical term in a corresponding scenario are added.
Output: A far field effect of this system is not good.

Example 4 is a punctuation adding scenario.
Input: This is a very long sentence does a punctuation need to be added I think so (where the input is speech representation information in a speech modality). Corresponding prompt words such as “a comma, a question mark, or a full stop” and other punctuations are added.
Output: This is a very long sentence. Does a punctuation need to be added? I think so.

In this embodiment of this application, a speech feature extraction model, for example, an ASR model, aligns the speech representation information to text semantic space of the LLM model by multiplexing a word embedding mechanism of the LLM model, so that the speech representation information may be directly used as an input of the LLM model. Because the speech representation information includes text content and paralinguistic information, the LLM model can make full use of information about the speech modality, thereby further improving capabilities of speech recognition and understanding. Other information than text content in the speech data can be fully used by using the LLM model, thereby enhancing capabilities of speech recognition and speech understanding. During speech recognition, different prompt words are provided, to directly improve capabilities such as de-colloquialized, hot word replacement, emotion recognition, and punctuation addition of speech recognition in a speech recognition operation, to form an end-to-end model, so that corresponding text information is outputted. This is rather than first recognizing a text in the speech recognition operation, and then transmitting the text to the LLM model for processing. The technical solution of this application may be further extended to information in another modality, for example, visual information, and is jointly used as an input of the LLM model, to further enhance capabilities of speech recognition and speech understanding of the model.

In this embodiment of this application, the speech conversion model is trained, and speech conversion processing may be performed on the speech fusion feature by using the trained speech conversion model to obtain the text information corresponding to a to-be-processed speech data, thereby improving efficiency of speech data processing. Because a large amount of sample speech data is used to train the speech conversion model, accuracy of the speech conversion model can be improved.

The foregoing describes the method in embodiments of this application, and the following describes an apparatus in embodiments of this application.

FIG. 8 is a schematic diagram of a composition structure of a speech processing apparatus according to an embodiment of this application. The speech processing apparatus may be disposed in a computer device. The speech processing apparatus may be configured to perform corresponding operations in the speech processing method provided in this embodiment of this application. The speech processing apparatus 80 includes:
a feature extraction unit 801, configured to perform feature extraction on to-be-processed speech data to obtain target speech representation information of the to-be-processed speech data, the target speech representation information including a speech content vector and a paralinguistic vector that correspond to the to-be-processed speech data, and the paralinguistic vector being configured for assisting in recognizing text information corresponding to the to-be-processed speech data;
an information fusion unit 802, configured to obtain a prompt word about the to-be-processed speech data, and perform fusion processing on the speech content vector, the paralinguistic vector, and the prompt word, to obtain a speech fusion feature; and
a speech conversion unit 803, configured to perform speech conversion processing on the to-be-processed speech data according to the speech fusion feature, to obtain the text information corresponding to the to-be-processed speech data.

In some embodiments, the information fusion unit 802 is specifically configured to:
perform feature conversion on the prompt word by using a feature conversion parameter, to obtain an eigenvector matrix corresponding to the prompt word; and
perform feature splicing on the speech content vector, the paralinguistic vector, and the eigenvector matrix corresponding to the prompt word, to obtain the speech fusion feature.

In some embodiments, the feature extraction unit 801 is specifically configured to:
obtain the feature conversion parameter configured for performing feature conversion on the prompt word;
perform feature encoding on the to-be-processed speech data, to obtain a speech vector matrix of the to-be-processed speech data; and
perform feature conversion on the speech vector matrix of the to-be-processed speech data by using the feature conversion parameter, to obtain the target speech representation information of the to-be-processed speech data, where a dimension of an eigenvector matrix represented by the target speech representation information is the same as a dimension of the eigenvector matrix corresponding to the prompt word.

In some embodiments, the feature extraction unit 801 is specifically configured to:
divide the to-be-processed speech data, to obtain N audio frames;
perform feature encoding on the audio frames, to obtain a speech vector matrix of the audio frames;
perform feature conversion on the speech vector matrix of the audio frames by using the feature conversion parameter, to obtain candidate speech representation information of the audio frames;
traverse the N audio frames, and predict, based on candidate speech representation information of a currently traversed audio frame, probabilities that the currently traversed audio frame is mapped to words in speech content, where the speech content is content indicated by the speech content vector;
delete the candidate speech representation information of the currently traversed audio frame from the candidate speech representation information of each audio frame if a maximum probability in the probabilities that the currently traversed audio frame is mapped to the words in the speech content is less than a probability threshold; and
obtain the target speech representation information of the to-be-processed speech data based on remaining candidate speech representation information after the traversal is completed.

In some embodiments, the feature extraction unit 801 is specifically further configured to:
determine a position feature of each audio frame based on a division sequence of the N audio frames, where the position feature is configured for indicating a position of a corresponding audio frame in the to-be-processed speech data.

The feature extraction unit 801 is specifically configured to:
perform feature encoding on each audio frame, to obtain encoding features of the N audio frames; and
perform, for an audio frame i in the N audio frames, feature splicing on a position feature of the audio frame i and an encoding feature of the audio frame i, to obtain a speech vector matrix of the audio frame i, where i is a positive integer and 1≤i≤N.

In some embodiments, the text information corresponding to the to-be-processed speech data is obtained by using a trained speech conversion model. The speech processing apparatus 80 further includes a first training unit 804, and the first training unit 804 is configured to:
obtain sample speech representation information and a sample prompt word that correspond to a sample speech data, where the sample speech representation information includes a sample speech content vector and a sample paralinguistic vector that correspond to the sample speech data;
perform fusion processing on the sample speech content vector, the sample paralinguistic vector, and the sample prompt word by using a speech conversion model, to obtain a sample speech fusion feature;
perform speech conversion processing on the sample speech data according to the sample speech fusion feature by using the speech conversion model, to obtain text information corresponding to the sample speech data; and
obtain a sample text label corresponding to the sample speech data, and train the speech conversion model based on the sample text label and the text information corresponding to the sample speech data, to obtain the trained speech conversion model.

In some embodiments, the target speech representation information of the to-be-processed speech data is obtained by using a trained speech feature extraction model. The speech processing apparatus 80 further includes a second training unit 805, and the second training unit 805 is configured to:
obtain the sample speech data, and perform feature extraction on the sample speech data by using a speech feature extraction model, to obtain the sample speech representation information of the sample speech data; and
obtain a sample speech representation label of the sample speech data, and train the speech feature extraction model based on the sample speech representation label and the sample speech representation information, to obtain the trained speech feature extraction model.

In some embodiments, the speech feature extraction model includes a speech vector matrix extraction layer and a speech representation full connection layer. The second training unit 805 is specifically configured to:
perform feature encoding on the sample speech data by using the speech vector matrix extraction layer, to obtain a speech vector matrix of the sample speech data;
perform feature conversion on the speech vector matrix of the sample speech data by using a feature conversion parameter in the speech representation full connection layer, to obtain the sample speech representation information of the sample speech data; and
adjust a parameter of the speech vector matrix extraction layer based on the sample speech representation label and the sample speech representation information, to obtain the trained speech feature extraction model.

For content not mentioned in the embodiment corresponding to FIG. 8, reference may be made to the descriptions in the method embodiment. Details are not described herein again.

In embodiments of this application, feature extraction is performed on to-be-processed speech data to obtain target speech representation information of the to-be-processed speech data. A prompt word about the to-be-processed speech data is obtained, and fusion processing is performed on the target speech representation information and the prompt word, to obtain a speech fusion feature. Speech conversion processing is performed on the speech fusion feature, to obtain text information corresponding to the to-be-processed speech data. The target speech representation information includes a speech content vector and a paralinguistic vector that correspond to the to-be-processed speech data, and the paralinguistic vector is configured for assisting in recognizing the text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word. Because more comprehensive and abundant speech representation information is used for speech recognition processing, in this application, deep speech recognition and understanding on the to-be-processed speech data can be implemented, thereby improving accuracy of the speech recognition.

FIG. 9 is a schematic diagram of a composition structure of a computer device according to an embodiment of this application. As shown in FIG. 9, the computer device 90 may include a processor 901, a memory 902, and a network interface 903. The processor 901 is connected to the memory 902 and the network interface 903. For example, the processor 901 may be connected to the memory 902 and the network interface 903 through a bus. The computer device may be a terminal device or a server.

The processor 901 is configured to support the speech processing apparatus to perform a corresponding function in the foregoing speech processing method. The processor 901 may be a central processing unit (CPU), a network processor (NP), a hardware chip, or any combination thereof. The hardware chip may be an application-specific integrated circuit (ASIC), a programmable logic device (PLD), or the like. The PLD may be a complex programmable logic device (CPLD), a field-programmable gate array (FPGA), a generic array logic (GAL), or the like.

The memory 902 is a memory configured to store program instructions, data, and the like. The memory 902 may include a volatile memory (VM), for example, a random access memory (RAM). The memory 902 may also include a non-volatile memory (NVM), for example, a read-only memory (ROM), a flash memory, a hard disk drive (HDD), or a solid-state drive (SSD). The memory 902 may further include a combination of the foregoing types of the memories.

The network interface 903 is configured to provide a network communication function.

The processor 901 may invoke a program code to perform the following operations:
performing feature extraction on to-be-processed speech data to obtain target speech representation information of the to-be-processed speech data, the target speech representation information including a speech content vector and a paralinguistic vector that correspond to the to-be-processed speech data, and the paralinguistic vector being configured for assisting in recognizing text information corresponding to the to-be-processed speech data;
obtaining a prompt word about the to-be-processed speech data, and performing fusion processing on the speech content vector, the paralinguistic vector, and the prompt word, to obtain a speech fusion feature; and
performing speech conversion processing on the to-be-processed speech data according to the speech fusion feature, to obtain the text information corresponding to the to-be-processed speech data.

The computer device 90 described in this embodiment of this application may perform the descriptions for the speech processing method in the foregoing embodiment corresponding to FIG. 3, FIG. 5, and FIG. 6, and may alternatively perform the descriptions for the data processing apparatus in the foregoing embodiment corresponding to FIG. 8. Details are not described herein again. In addition, the descriptions of beneficial effects of the same method are not described herein again.

In embodiments of this application, feature extraction is performed on the to-be-processed speech data to obtain the target speech representation information of the to-be-processed speech data. A prompt word about the to-be-processed speech data is obtained, and fusion processing is performed on the target speech representation information and the prompt word, to obtain a speech fusion feature. Speech conversion processing is performed on the speech fusion feature, to obtain text information corresponding to the to-be-processed speech data. The target speech representation information includes a speech content vector and a paralinguistic vector that correspond to the to-be-processed speech data, and the paralinguistic vector is configured for assisting in recognizing the text information corresponding to the to-be-processed speech data. Therefore, when speech recognition is performed on the to-be-processed speech data, the speech recognition may be performed in combination with information about speech content of the to-be-processed speech data, information about paralanguage in the to-be-processed speech data, and text content corresponding to the prompt word. Because more comprehensive and abundant speech representation information is used for speech recognition processing, in this application, deep speech recognition and understanding on the to-be-processed speech data can be implemented, thereby improving accuracy of the speech recognition.

In some embodiments, when the program instruction is executed by the processor, other operations of the method in the foregoing embodiments may be further implemented. Details are not described herein again.

This embodiment of this application further provides a non-transitory computer-readable storage medium. The computer-readable storage medium stores a computer program. The computer program includes program instructions. When the program instructions are executed by a computer, the computer performs the method in the foregoing embodiments. The computer may be a part of the computer device mentioned above. As an example, the program instructions may be deployed to be executed on the computer device, deployed to be executed on a plurality of computer devices at one location, or deployed to be executed on a plurality of computer devices that are distributed in a plurality of locations and interconnected through a communication network. The plurality of computer devices that are distributed in the plurality of locations and interconnected through the communication network may form a blockchain network.

This embodiment of this application further provides a computer program product or a computer program. The computer program product or the computer program includes computer instructions. When the computer instructions are executed by a processor, some or all operations of the foregoing method may be implemented. For example, the computer instructions are stored in a non-transitory computer-readable storage medium. A processor of a computer device reads the computer instructions from the computer-readable storage medium, and the processor executes the computer instructions, so that the computer device performs the operations performed in embodiments of the foregoing method.

A person of ordinary skill in the art may understand that, all or some of the procedures of the method in the foregoing embodiments may be implemented by a computer program instructing relevant hardware. The program may be stored in a non-transitory computer-readable storage medium. When the program is executed, the procedures of the foregoing method embodiments may be included. The storage medium may be a magnetic disk, an optical disc, a read-only memory (ROM), a random access memory (RAM), or the like.

In the embodiments of this application, the term “unit” refers to a computer program with a preset function or a part of the computer program and works, together with other related parts, to implement a preset target, which may be completely or partially implemented by using software, hardware (such as a processing circuit or a memory) or a combination thereof. Similarly, one processor (or a plurality of processors or memories) may be configured to implement one or more units. In addition, each unit may be a part of an overall unit including a function of the unit. What is disclosed above is merely exemplary embodiments of this application, and certainly is not intended to limit the protection scope of this application. Therefore, equivalent variations made in accordance with the claims of this application shall fall within the scope of this application.

What is claimed is:

1. A speech-to-text conversion method, the method comprising:
extracting target speech representation information from to-be-processed speech data, the target speech representation information comprising a speech content vector and a paralinguistic vector that correspond to the to-be-processed speech data;
obtaining a prompt word about the to-be-processed speech data;
performing fusion processing on the speech content vector, the paralinguistic vector, and the prompt word, to obtain a speech fusion feature; and
performing speech conversion processing on the to-be-processed speech data according to the speech fusion feature, to obtain the text information corresponding to the to-be-processed speech data.

2. The method according to claim 1, wherein the performing fusion processing on the speech content vector, the paralinguistic vector, and the prompt word, to obtain a speech fusion feature comprises:
performing feature conversion on the prompt word by using a feature conversion parameter, to obtain an eigenvector matrix corresponding to the prompt word; and
performing feature splicing on the speech content vector, the paralinguistic vector, and the eigenvector matrix corresponding to the prompt word, to obtain the speech fusion feature.

3. The method according to claim 1, wherein the extracting target speech representation information from to-be-processed speech data comprises:
obtaining a feature conversion parameter configured for performing feature conversion on the prompt word;
performing feature encoding on the to-be-processed speech data, to obtain a speech vector matrix of the to-be-processed speech data; and
performing feature conversion on the speech vector matrix of the to-be-processed speech data by using the feature conversion parameter, to obtain the target speech representation information of the to-be-processed speech data.

4. The method according to claim 3, wherein a dimension of an eigenvector matrix represented by the target speech representation information is the same as a dimension of the eigenvector matrix corresponding to the prompt word.

5. The method according to claim 1, wherein the text information corresponding to the to-be-processed speech data is obtained by using a speech conversion model, and the speech conversion model is trained by:
obtaining sample speech representation information, a sample text label and a sample prompt word that correspond to sample speech data, wherein the sample speech representation information comprises a sample speech content vector and a sample paralinguistic vector that correspond to the sample speech data;
performing fusion processing on the sample speech content vector, the sample paralinguistic vector, and the sample prompt word by using a speech conversion model, to obtain a sample speech fusion feature;
performing speech conversion processing on the sample speech data according to the sample speech fusion feature by using the speech conversion model, to obtain text information corresponding to the sample speech data; and
training the speech conversion model based on the sample text label and the text information corresponding to the sample speech data, to obtain the trained speech conversion model.

6. The method according to claim 1, wherein the target speech representation information of the to-be-processed speech data is obtained by using a speech feature extraction model, and the speech feature extraction model is trained by:
performing feature extraction on sample speech data by using a speech feature extraction model, to obtain sample speech representation information of the sample speech data; and
training the speech feature extraction model based on a sample speech representation label and the sample speech representation information, to obtain the trained speech feature extraction model.

7. The method according to claim 6, wherein the speech feature extraction model comprises a speech vector matrix extraction layer and a speech representation full connection layer; the method further comprises:
performing feature encoding on the sample speech data by using the speech vector matrix extraction layer, to obtain a speech vector matrix of the sample speech data; and
performing feature conversion on the speech vector matrix of the sample speech data by using a feature conversion parameter in the speech representation full connection layer, to obtain the sample speech representation information of the sample speech data; and
adjusting a parameter of the speech vector matrix extraction layer based on the sample speech representation label and the sample speech representation information, to obtain the trained speech feature extraction model.

8. The method according to claim 1, wherein the paralinguistic vector is configured for assisting in recognizing text information corresponding to the to-be-processed speech data.

9. A computer device, comprising a processor, a memory, and a network interface, the processor being connected to the memory and the network interface, the network interface being configured to provide a data communication function, the memory being configured to store a computer program, and the processor being configured to invoke the computer program, to cause the computer device to perform a speech-to-text conversion method including:
extracting target speech representation information from to-be-processed speech data, the target speech representation information comprising a speech content vector and a paralinguistic vector that correspond to the to-be-processed speech data;
obtaining a prompt word about the to-be-processed speech data;
performing fusion processing on the speech content vector, the paralinguistic vector, and the prompt word, to obtain a speech fusion feature; and
performing speech conversion processing on the to-be-processed speech data according to the speech fusion feature, to obtain the text information corresponding to the to-be-processed speech data.

10. The computer device according to claim 9, wherein the performing fusion processing on the speech content vector, the paralinguistic vector, and the prompt word, to obtain a speech fusion feature comprises:
performing feature conversion on the prompt word by using a feature conversion parameter, to obtain an eigenvector matrix corresponding to the prompt word; and
performing feature splicing on the speech content vector, the paralinguistic vector, and the eigenvector matrix corresponding to the prompt word, to obtain the speech fusion feature.

11. The computer device according to claim 9, wherein the extracting target speech representation information from to-be-processed speech data comprises:
obtaining a feature conversion parameter configured for performing feature conversion on the prompt word;
performing feature encoding on the to-be-processed speech data, to obtain a speech vector matrix of the to-be-processed speech data; and
performing feature conversion on the speech vector matrix of the to-be-processed speech data by using the feature conversion parameter, to obtain the target speech representation information of the to-be-processed speech data.

12. The computer device according to claim 11, wherein a dimension of an eigenvector matrix represented by the target speech representation information is the same as a dimension of the eigenvector matrix corresponding to the prompt word.

13. The computer device according to claim 9, wherein the text information corresponding to the to-be-processed speech data is obtained by using a speech conversion model, and the speech conversion model is trained by:
obtaining sample speech representation information, a sample text label and a sample prompt word that correspond to sample speech data, wherein the sample speech representation information comprises a sample speech content vector and a sample paralinguistic vector that correspond to the sample speech data;
performing fusion processing on the sample speech content vector, the sample paralinguistic vector, and the sample prompt word by using a speech conversion model, to obtain a sample speech fusion feature;
performing speech conversion processing on the sample speech data according to the sample speech fusion feature by using the speech conversion model, to obtain text information corresponding to the sample speech data; and
training the speech conversion model based on the sample text label and the text information corresponding to the sample speech data, to obtain the trained speech conversion model.

14. The computer device according to claim 9, wherein the target speech representation information of the to-be-processed speech data is obtained by using a speech feature extraction model, and the speech feature extraction model is trained by:
performing feature extraction on sample speech data by using a speech feature extraction model, to obtain sample speech representation information of the sample speech data; and
training the speech feature extraction model based on a sample speech representation label and the sample speech representation information, to obtain the trained speech feature extraction model.

15. The computer device according to claim 14, wherein the speech feature extraction model comprises a speech vector matrix extraction layer and a speech representation full connection layer; the method further comprises:
performing feature encoding on the sample speech data by using the speech vector matrix extraction layer, to obtain a speech vector matrix of the sample speech data; and
performing feature conversion on the speech vector matrix of the sample speech data by using a feature conversion parameter in the speech representation full connection layer, to obtain the sample speech representation information of the sample speech data; and
adjusting a parameter of the speech vector matrix extraction layer based on the sample speech representation label and the sample speech representation information, to obtain the trained speech feature extraction model.

16. The computer device according to claim 9, wherein the paralinguistic vector is configured for assisting in recognizing text information corresponding to the to-be-processed speech data.

17. A non-transitory computer-readable storage medium, storing a computer program, and the computer program being suitable for being loaded and executed by a processor, to cause a computer device having the processor to perform a speech-to-text conversion method including:
extracting target speech representation information from to-be-processed speech data, the target speech representation information comprising a speech content vector and a paralinguistic vector that correspond to the to-be-processed speech data;
obtaining a prompt word about the to-be-processed speech data;
performing fusion processing on the speech content vector, the paralinguistic vector, and the prompt word, to obtain a speech fusion feature; and
performing speech conversion processing on the to-be-processed speech data according to the speech fusion feature, to obtain the text information corresponding to the to-be-processed speech data.

18. The non-transitory computer-readable storage medium according to claim 17, wherein the performing fusion processing on the speech content vector, the paralinguistic vector, and the prompt word, to obtain a speech fusion feature comprises:
performing feature conversion on the prompt word by using a feature conversion parameter, to obtain an eigenvector matrix corresponding to the prompt word; and
performing feature splicing on the speech content vector, the paralinguistic vector, and the eigenvector matrix corresponding to the prompt word, to obtain the speech fusion feature.

19. The non-transitory computer-readable storage medium according to claim 17, wherein the extracting target speech representation information from to-be-processed speech data comprises:
obtaining a feature conversion parameter configured for performing feature conversion on the prompt word;
performing feature encoding on the to-be-processed speech data, to obtain a speech vector matrix of the to-be-processed speech data; and
performing feature conversion on the speech vector matrix of the to-be-processed speech data by using the feature conversion parameter, to obtain the target speech representation information of the to-be-processed speech data.

20. The non-transitory computer-readable storage medium according to claim 17, wherein the paralinguistic vector is configured for assisting in recognizing text information corresponding to the to-be-processed speech data.
